(19) United States
(12) Patent Application Publication
(10) Pub. No.: US 2021/0312327 A1
(43) Pub. Date: Oct. 7, 2021

(54) LEARNING DATA SET GENERATION DEVICE, LEARNING DATA SET GENERATION METHOD, AND RECORDING MEDIUM

(71) Applicant: NEC Corporation, Minato-ku, Tokyo (JP)

(72) Inventors: Eiji KANEKO, Tokyo (JP); Takahiro TOIZUMI, Tokyo (JP); Kazutoshi SAGI, Tokyo (JP); Masato TODA, Tokyo (JP)

(73) Assignee: NEC Corporation, Minato-ku, Tokyo (JP)

(21) Appl. No.: 17/057,916

(22) PCT Filed: May 28, 2018
(86) PCT No.: PCT/JP2018/020308

§ 371 Date: Nov. 23, 2020

(51) Int. Cl. G06N 20/00; G06T 5/00; G06T 5/50; G06K 9/00; G06K 9/62

(52) U.S. Cl. CPC G06N 20/00; G06T 5/001; G06T 5/50; G06T 2207/10032; G06K 9/6202; G06T 2207/20081; G06K 9/0063

(57) ABSTRACT

Provided is to generate learning data set for learning a cloud correction processing method. A device includes: synthesis unit configured to have a more cloud image and a less cloud image including a same observation object as a set, and receive a first thick cloud area indicating a thick cloud in the more cloud image and a second thick cloud area indicating the thick cloud in the less cloud image; execute a first operation for the first and/or second thick cloud area to generate a first mask in the less cloud image; execute a second operation for the first and/or second thick cloud area to generate a second mask in the more cloud image; and adopt, as learning data, the set including data including the generated first mask and the more cloud image and data including the generated second mask and the less cloud image.

### TECHNICAL FIELD

The present invention relates to a learning data set generation device for generating a data set for learning image processing.

### BACKGROUND ART

There is a technology called remote sensing for observing a ground surface by an observation device from a high place such as an artificial satellite or aircraft. Since two-thirds of the earth is covered with clouds, many of images include clouds in a case where the ground surface is captured from an artificial satellite using the remote sensing technology. In an image including clouds, there is a method using machine learning as one of methods for restoring information of the ground surface hidden in the clouds. In this method, a cloud correction method learning unit learns parameters of a cloud correction method using a learning data set as an input, and corrects a cloud of the input image in accordance with the learned parameters. The learning data set is a collection of a large number of sets of images with clouds including clouds and cloudless images including no clouds, which are obtained by capturing the same location. Desirable conditions for the learning data set are that there are many sets of images, that the images are actually observed, and that conditions other than the presence or absence of clouds are consistent. The clouds included in the images with clouds are roughly divided into a thin cloud that transmits sunlight and through which the ground surface can be observed even slightly and a thick cloud that does not transmit sunlight and through which the ground surface cannot be observed at all.

NPL 1 discloses a technique of superimposing clouds on an image not including clouds (thin clouds) and generating a set of a cloudless image and an image with clouds as a learning data set. A configuration of a device used in NPL 1 is illustrated in FIG. 11. The device disclosed in NPL 1 includes a cloud superposition unit 01, a learning data set storage unit 02, a cloud correction method learning unit 03, and a cloud correction processing unit 04. The cloud superposition unit 01 reflects a simulation result of an influence by clouds in the cloudless image, using the cloudless image as an input, and generates an image with clouds. The learning data set storage unit 02 stores a large number of sets of the image with clouds generated by the cloud superposition unit 01 and the cloudless image used for generating the image with clouds. The cloud correction method learning unit 03 learns parameters of cloud correction processing using the learning data set stored in the learning data set storage unit 02. The cloud correction processing unit 04 corrects the influence of the clouds included in the input image, using the parameters learned by the cloud correction method learning unit 03, and outputs a corrected image.

PTL 1 discloses a technique of extracting a learning data set (an image with clouds and a cloudless image at the same location) to be used for machine learning from a database of actually observed images, and generating a learning data set.

In addition, NPL 2 is a related document.

### CITATION LIST

### Patent Literature

[PTL 1] JP 2004-213567 A

### Non Patent Literature

[NPL 1] Kenji Enomoto, Ken Sakurada, Weimin Wang, Hiroshi Fukui, Masashi Matsuoka, Ryosuke Nakamura and Nobuo Kawaguchi, “Filmy Cloud Removal on Satellite Imagery with Multispectral Conditional Generative Adversarial Nets,” Conference on Computer Vision and Pattern Recognition Workshop (CVPRW) EARTHVISION 2017
[NPL 2] DHANASHREE GADKARI, “IMAGE QUALITY ANALYSIS USING GLCM,” A thesis submitted in partial fulfillment of the requirements for the degree of Master of Science in Modeling and Simulation in the College of Arts and Sciences at the University of Central Florida Orlando, Fla., 2004

### SUMMARY OF INVENTION

### Technical Problem

However, the method disclosed in NPL 1 cannot generate a learning data set suitable for generating cloud correction processing. This is because the image with clouds obtained by the method disclosed in NPL 1 is obtained by the cloud superposition unit calculating the influence of the clouds (thin clouds) and synthesizing the influence with the cloudless image. This synthesized image cannot completely reproduce an image of natural clouds that may be actually observed.

Further, in the method disclosed in PTL 1, even in the case where an image is extracted from the database of actually observed images and the learning data set is generated, the learning data set suitable for generating the cloud correction processing cannot be generated. This is because, in a case where the image including thin clouds extracted by the method includes a thick cloud even if the amount is small (for example, in a case where a center portion of the thin cloud is a thick cloud), the cloud correction method learning unit learns processing of obtaining a value close to information of the ground surface from the thick cloud that does not include the information of the ground surface, and cannot correctly learn the processing of restoring the information of the ground surface included in the thin cloud.

In view of the above problem, one of objects of the present invention is to provide a learning data set generation device capable of generating a learning data set suitable for cloud correction processing using a natural cloud image.

### Solution to Problem

In view of the above problem, a learning data set generation device as the first aspect of the present invention includes a synthesis means for having a more cloud image including a cloud and a less cloud image including a smaller cloud amount than the more cloud image or not including a cloud among images including a same observation object as a set, using a first thick cloud area indicating a pixel of a thick cloud in the more cloud image and a second thick cloud area indicating a pixel of the thick cloud in the less cloud image as inputs, executing a first operation for at least one of the first thick cloud area and the second thick cloud area to generate a first mask for masking the first thick cloud area in the less cloud image, and executing a second operation for at least one of the first thick cloud area and the second thick cloud area to generate a second mask for masking the second thick cloud area in the more cloud image, and

the set including information including the generated first mask and the more cloud image, and information including the generated second mask and the less cloud image is adopted as learning data.

A learning data set generation method as the second aspect of the present invention includes

having a more cloud image including a cloud and a less cloud image including a smaller cloud amount than the more cloud image or not including a cloud among images including a same observation object as a set, and receiving a first thick cloud area indicating a pixel of a thick cloud in the more cloud image and a second thick cloud area indicating a pixel of the thick cloud in the less cloud image,

executing a first operation for at least one of the first thick cloud area and the second thick cloud area to generate a first mask for masking the first thick cloud area in the less cloud image, and

executing a second operation for at least one of the first thick cloud area and the second thick cloud area to generate a second mask for masking the second thick cloud area in the more cloud image, in which

the set including information including the generated first mask and the more cloud image, and information including the generated second mask and the less cloud image is adopted as learning data.

A learning data set generation program as the third aspect of the present invention is

an image processing program for causing a computer to implement

having a more cloud image including a cloud and a less cloud image including a smaller cloud amount than the more cloud image or not including a cloud among images including a same observation object as a set, and receiving a first thick cloud area indicating a pixel of a thick cloud in the more cloud image and a second thick cloud area indicating a pixel of the thick cloud in the less cloud image,

executing a first operation for at least one of the first thick cloud area and the second thick cloud area to generate a first mask for masking the first thick cloud area in the less cloud image,

executing a second operation for at least one of the first thick cloud area and the second thick cloud area to generate a second mask for masking the second thick cloud area in the more cloud image, and

adopting the set including information including the generated first mask and the more cloud image, and information including the generated second mask and the less cloud image, as learning data.

The learning data set generation program may be stored on a non-temporary computer-readable storage medium.

### Advantageous Effects of Invention

According to the present invention, a learning data set generation device and the like capable of generating a learning data set suitable for cloud correction processing using a natural cloud image can be provided.

### BRIEF DESCRIPTION OF DRAWINGS

FIG. 1 is a schematic diagram illustrating light observed as a value of a thick cloud pixel.

FIG. 2 is a schematic diagram illustrating light observed as a value of a thin cloud pixel.

FIG. 3A is a diagram illustrating an example of an input image and an output image used for learning.

FIG. 3B is a diagram illustrating an example of an input image from which a cloud is to be removed and corrected and an output image.

FIG. 4 is a block diagram illustrating a configuration example of a learning data set generation device according to a first example embodiment of the present invention.

FIG. 5 is a diagram illustrating an example of two input images (a more cloud image and a less cloud image) used for learning.

FIG. 6 is a diagram illustrating an example of processing of generating a mask from thick cloud areas of two input images.

FIG. 7 is a diagram illustrating an example of generated mask images.

FIG. 8 is a flowchart illustrating an operation in a learning data set generation device according to a first example embodiment of the present invention.

FIG. 9 is a block diagram illustrating a configuration example of a learning data set generation device according to a second example embodiment of the present invention.

FIG. 10 is a block diagram illustrating a configuration example of an information processing device applicable to each example embodiment.

FIG. 11 is a diagram illustrating an internal configuration of a device used in NPL 1.

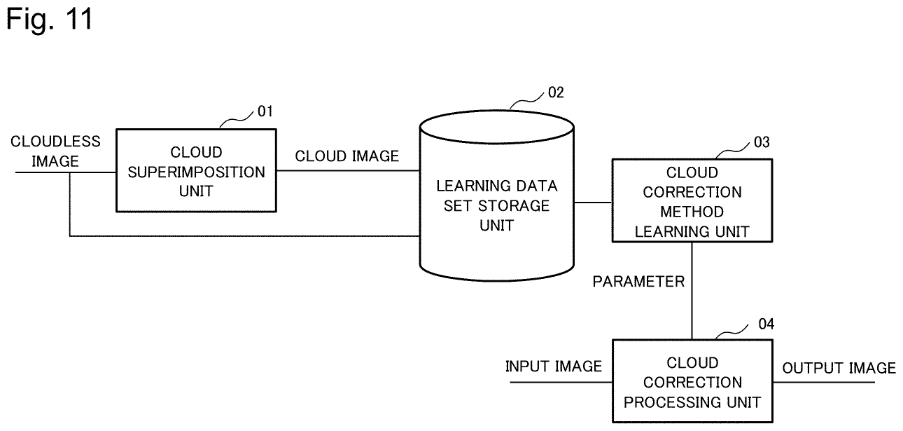

### EXAMPLE EMBODIMENT

In a remote sensing technology, intensity of electromagnetic waves of light emitted from an area in a predetermined range of a ground surface is observed. An observation result obtained by the remote sensing is expressed as a pixel value. The pixel value is value data associated with a pixel related to a position on the ground surface of the observed area in an image. For example, in the case where an observation device is an image sensor, the pixel value included in the observed image is a value of the intensity of light (observed light) incident on a light-receiving element of the image sensor, the intensity being observed by the light-receiving element.

In the case where the pixel value is a value representing brightness of at least one wavelength band for each wavelength band of the observed light, the value representing the brightness of the observed light is also referred to as luminance value. For example, a filter that selectively transmits light having a wavelength included in a wavelength band of a specific range is used for observation. By using a plurality of filters having different wavelength bands of transmitted light, the intensity of the observed light for each wavelength band can be obtained as an observation result.

Further, an object reflects light of different intensity for each wavelength depending on the material or state of its surface. The reflectance of light for each wavelength on the object is generally called surface reflectance. Development of an application for acquiring the state and material of an object in accordance with information (data) of the surface reflectance of the object included in a value of each pixel in an image obtained by the remote sensing is expected. This application executes, for example, making a map, grasping a state of land use, grasping a situation of volcanic eruptions or forest fires, acquiring a growth level of crops, or discriminating minerals in accordance with a result of measuring the ground surface from a high place. To properly execute the above matters, it is necessary to obtain accurate information about ground surface objects such as buildings, lava, forests, agricultural crops, or ores.

However, an image obtained by the remote sensing include many pixels affected by objects that affect visibility of the ground surface, such as clouds, gases, plumes, hot water, or aerosols. Hereinafter, description will be given using a cloud as a representative object that affects the visibility, and the influence by the cloud and the invention of removing the influence will be described. However, the object is not limited to a cloud, and any object may be adopted as long as the object affects the visibility in the atmosphere, such as a gas, smoke, hot water, or aerosol.

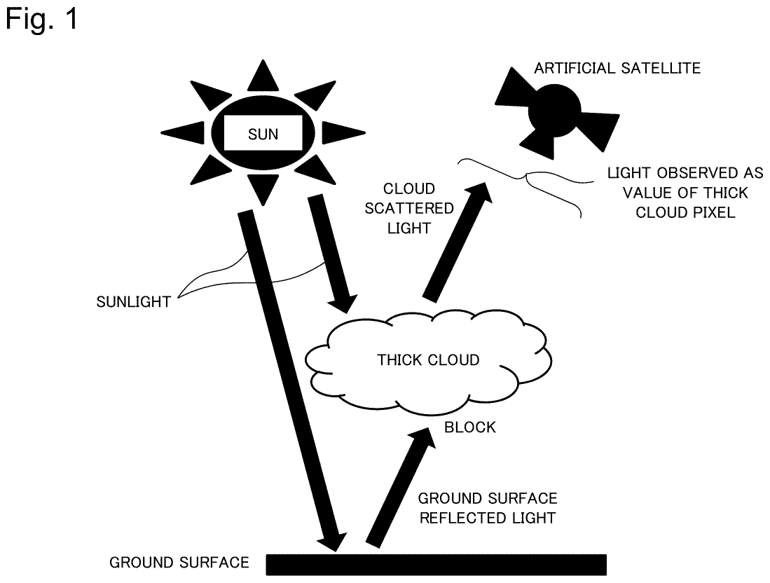

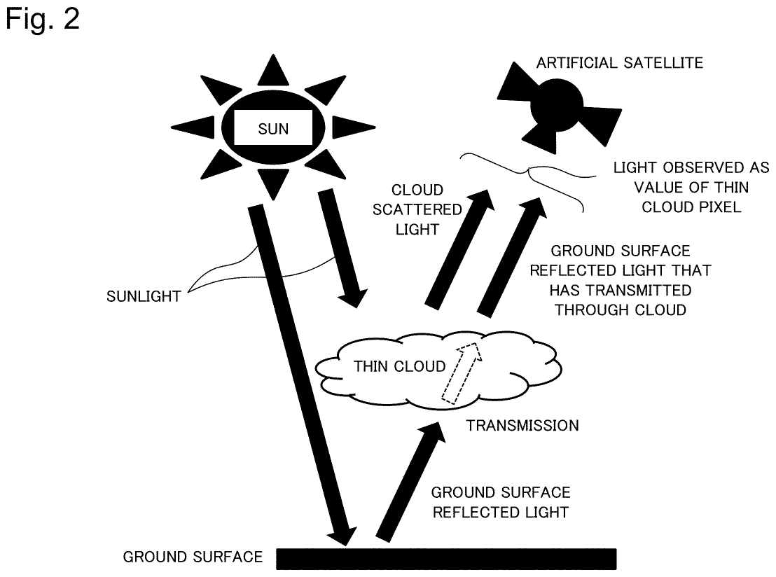

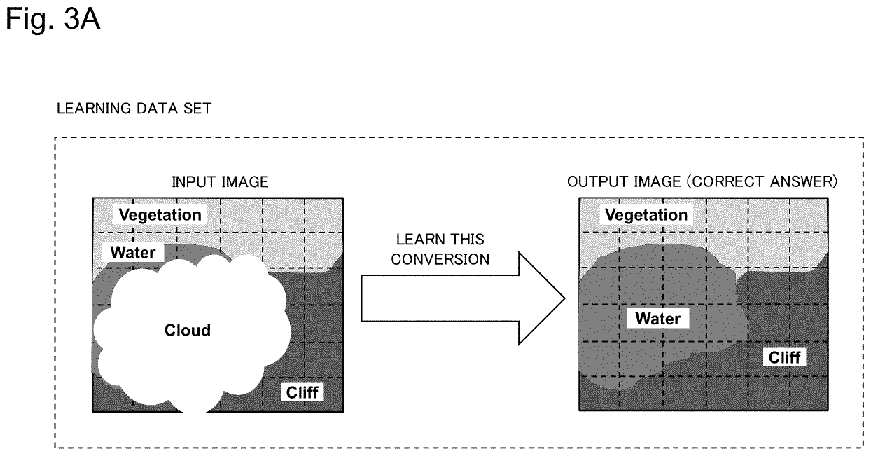

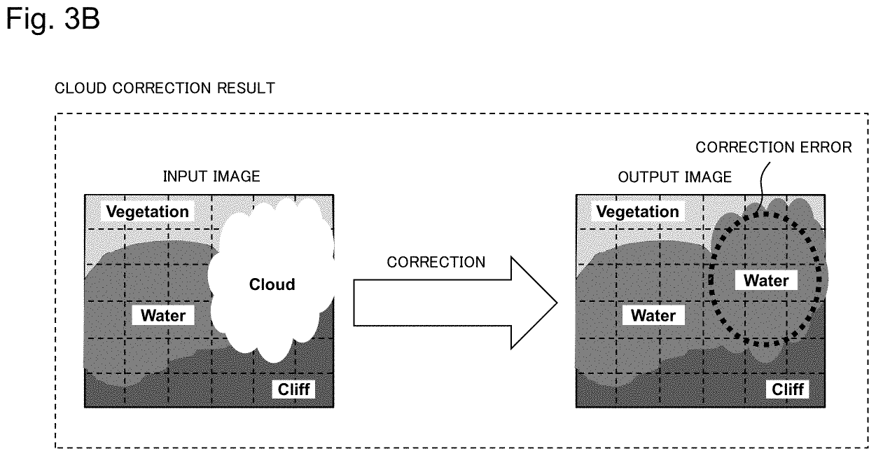

The pixels affected by the cloud are divided into thin cloud pixels and thick cloud pixels. FIG. 1 is a schematic diagram illustrating light observed as a value of a thick cloud pixel. FIG. 2 is a schematic diagram illustrating light observed as a value of a thin cloud pixel. The thick cloud pixel is a pixel that receives sunlight from the atmosphere and is affected only by light scattered outside and inside the cloud. The thin cloud pixel is a pixel that is affected not only by light scattered outside and inside the cloud but also by light reflected at the ground surface and transmitted through the cloud. Hereinafter, an image area occupied by the thick cloud pixels is referred to as a thick cloud area, and an image area occupied by the thin cloud pixels is referred to as a thin cloud area. As illustrated in FIG. 1, the sunlight is reflected at the ground surface and becomes ground-surface reflected light. However, since the thick cloud is thick, the ground-surface reflected light is blocked by the cloud. As a result, only cloud scattered light scattered by the cloud is observed by an artificial satellite as the thick cloud pixel. Meanwhile, in the case of the thin cloud, as illustrated in FIG. 2, the ground-surface reflected light is not blocked by the cloud, and the transmitted ground-surface reflected light and the cloud scattered light are observed by the artificial satellite as the thin cloud pixel. As a result, the thick cloud pixel has a value not including information of the ground surface, and the thin cloud pixel has a value in which the information of the ground surface is distorted by the influence of the cloud. Therefore, the inventors of the present application have found that a correct result cannot be obtained even using observation values of pixels affected by clouds (thick cloud and thin cloud) as they are for recognition and state estimation of an object on the ground, as disclosed in PTL 1 and NPL 1. In fact, there are some cases where erroneous image correction processing is executed when using the technologies disclosed by PTL 1 and NPL 1. This is because, in the case of learning the cloud correction processing using a data set including a thick cloud, the learning unit leans processing of generating a thick cloud or processing of restoring the information of the ground surface from the thick cloud not including the information of the ground surface, and thus cannot correctly learn the method of restoring the information of the ground surface from a thin cloud including the information of the ground surface. As a specific example, even if an input image including clouds (including a thin cloud and a thick cloud) is learned as illustrated in FIG. 3A, as a learning data set, the correction processing of converting the input image into a correct image is learned, and an output image is generated, an area of a cloud in an image is erroneously recognized as water and corrected although the area should be corrected as cliff, as illustrated in FIG. 3B, in actual operation. That is, the inventors have found that the types of clouds may be different even in a continuous cloud area, and a learning unit for appropriately removing clouds can be generated by discriminating the different types of clouds and generating the learning data, and performing machine learning for the cloud removal processing.

Therefore, in the present invention, in generating learning data for machine learning of removal of clouds, a thin cloud and a thick cloud are first discriminated, an influence by a cloud is corrected from an observation value in an area discriminated as the thin cloud, and information of a ground surface is restored. Moreover, the removal of clouds is machine-learned using the learning data, whereby a learning unit capable of appropriately removing clouds is generated. Hereinafter, example embodiments of the present invention will be described in detail with reference to the drawings.

### First Example Embodiment

(Learning Data Set Generation Device)

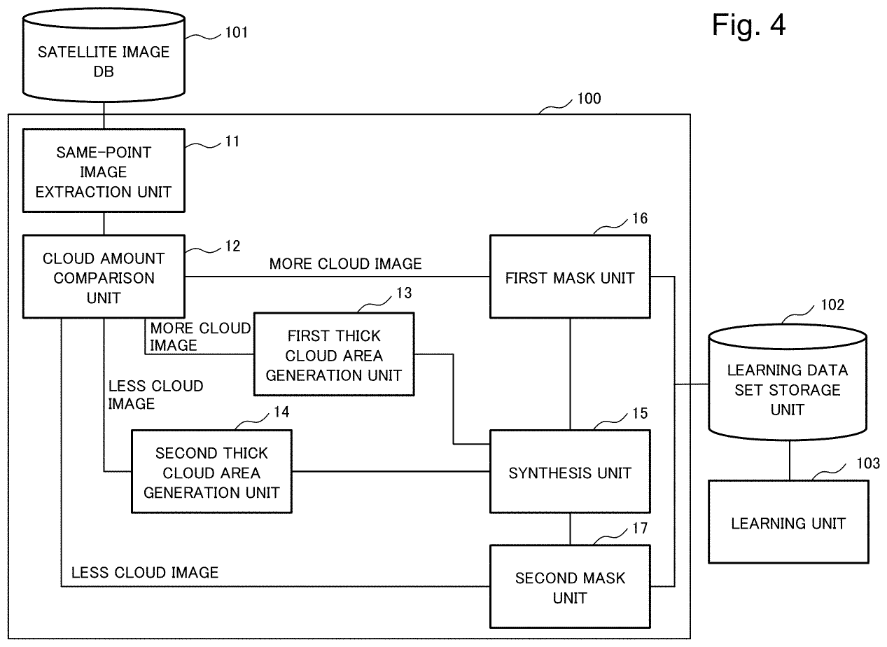

A configuration example of a learning data set generation device 100 according to a first example embodiment of the present invention will be described with reference to FIG. 4. The learning data set generation device 100 is communicably connected to a satellite image database (hereinafter, described as DB) 101 via a wireless communication line, for example. The learning data set generation device 100 is connected to a learning data set storage unit 102 via a wireless or wired communication line. The learning data set storage unit 102 is connected to a learning unit 103 via a wireless or wired communication line. Only data may be manually transferred.

The satellite image DB 101 stores an image observed (captured) by an artificial satellite and information related to the image, for example, information of a location of an observation object of the image. The information of a location of an observation object is, for example, latitude and longitude on the ground related to each pixel. The satellite image DB 101 may store information of an observed wavelength band as the information related to the image. The satellite image DB 101 may store one or a plurality of images, and a sensitivity value for each wavelength of an image sensor that observes the wavelength band associated with each image or upper and lower limits of the wavelength band. The satellite image DB 101 includes, for example, a hard disk storage device and a server that manages the hard disk storage device. In the description of the present example embodiment, an object to be captured as a satellite image is mainly a ground surface. The satellite image DB 101 is mounted on, for example, an airplane or an artificial satellite. The satellite images stored in the satellite image DB 101 are obtained by observing brightness of the ground surface from the sky in a plurality of wavelength bands different from one another. The satellite image is not limited to an image of the ground surface observed from the sky and may be an image of the distant ground surface observed from the ground surface or from a neighborhood of the ground surface. A width of the wavelength band observed as an image may not be uniform.

The learning data set storage unit 102 stores a large number of learning data sets. The learning data set includes an input image to be input to a learning unit that performs machine learning of cloud removal processing (hereinafter described as learning unit) 103, and a target image to be learned by the learning unit 103. The input image is, for example, an image partially covered with a cloud including a natural cloud at a point A. The target image is, for example, an image of only the ground surface including no cloud at the point A. Here, an image including more clouds is referred to as the input image, and an image including less clouds is referred to as the target image. This is for correcting a thin cloud included in the input image and learning in such a way that the target image becomes an image after correction (removal). The learning data set storage unit 102 includes, for example, a hard disk or a server.

The learning unit 103 executes actual cloud removal processing after sufficiently learning parameters using the learning data sets stored in the learning data set storage unit 102. That is, the learning unit 103 is used to automatically and randomly select two pairs of satellite images observed at the same point at different observation times as actual data, and execute the thin cloud correction processing.

The learning data set generation device 100 includes a same-point image extraction unit 11, a cloud amount comparison unit 12, a first thick cloud area generation unit 13, a second thick cloud area generation unit 14, a synthesis unit 15, a first mask unit 16, and a second mask unit 17.

The same-point image extraction unit 11 extracts a plurality of images including the same point as an observation object from the satellite image DB 101 via wireless communication, and outputs the images as same-point images. The plurality of images has been captured at the same location at different times. The same-point image extraction unit 11 selects a plurality of images including the same latitude and longitude as the latitude and longitude of an optional image by referring to the latitude and longitude of each pixel of the images stored in the satellite image DB 101, for example. The same-point image extraction unit 11 outputs the optional image and the plurality of selected images as same-point images.

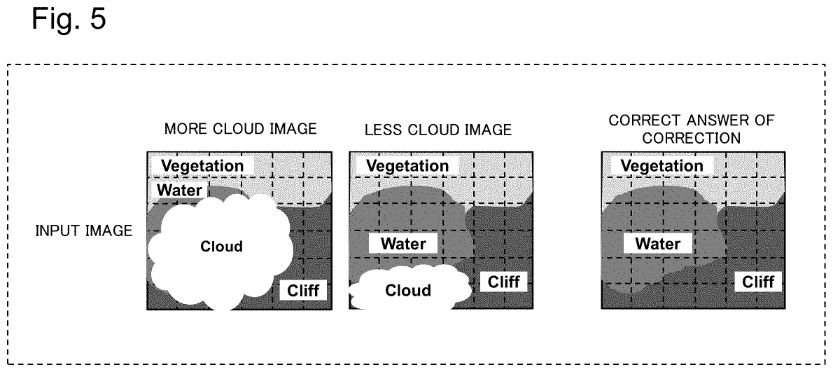

The cloud amount comparison unit 12 calculates a cloud amount included in each image in the plurality of images each including the same observation object (same point) and comparing the calculated cloud amount with a default value, thereby generating a set of a more cloud image having a cloud amount larger than the default value and a less cloud image having a cloud amount smaller than the default value. Specifically, the cloud amount comparison unit 12 calculates a cloud amount (an area constituted by only clouds, cloud area) included in each of the plurality of same-point images, and generates a set of an image including more clouds (hereinafter referred to as more cloud image) and an image without clouds or an image including less clouds (hereinafter referred to as less cloud image) in accordance with the calculated cloud amount (see FIG. 5). The cloud amount comparison unit 12 compares a luminance value associated with each pixel in the same-point image with a preset set value, and determines a pixel having a value larger than the set value as a cloud pixel. An area where the cloud pixels gather becomes a cloud area. The cloud amount comparison unit 12 calculates, in each image in which the same point is captured, a ratio of the number of pixels of the cloud area to the number of pixels of the entire image as a cloud ratio, sets an image with the cloud ratio having a value equal to or smaller than a default value as a less cloud image, and an image with the cloud ratio having a value larger than the default value as a more cloud image, and outputs a combination of the less cloud image and the more cloud image. Alternatively, the cloud amount comparison unit 12 may input each image of the same-point images to the gray level co-occurrence matrices (hereinafter GLCM) described in NPL 2, compare an index value representing homogeneity or an average value of each pixel calculated using the GLCM with a default value, and determine whether the pixel is included in a more cloud area or a less cloud area in accordance with a comparison result.

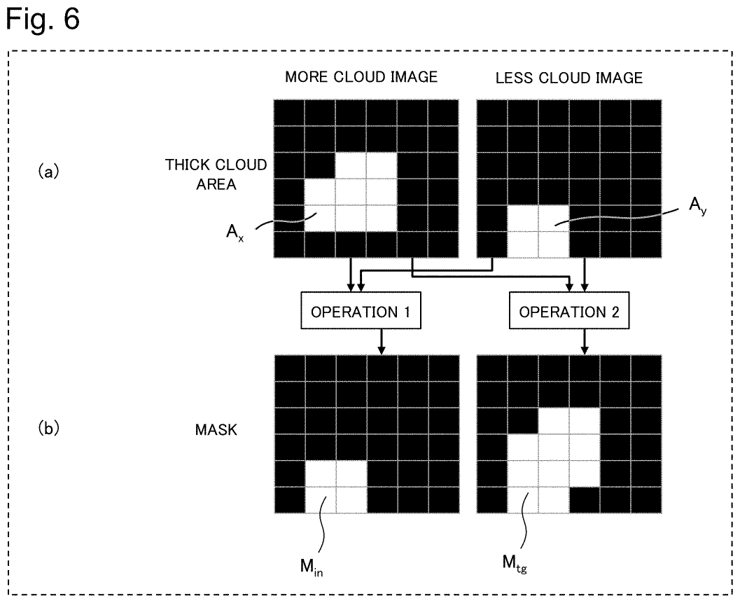

The first thick cloud area generation unit 13 uses the more cloud image of the set of images generated by the cloud amount comparison unit 12 as an input, and generates and outputs a first thick cloud area (Aₓ: see the left side of a pattern example (a) in FIG. 6) including a cloud thick enough not to transmit the light from the ground surface in the more cloud image. The first thick cloud area generation unit 13 compares the value (for example, the luminance value) stored in each pixel with a default value, and determines a pixel having a value equal to or larger than the default value as a part of the first thick cloud area, for example. Alternatively, the first thick cloud area generation unit 13 may calculate the GLCM described in NPL 2, using the more cloud image as an input, compare an index value representing homogeneity or an average value of each pixel of the more cloud image calculated using the calculated GLCM with a default value, and determine whether the pixel is included in the first thick cloud area in accordance with a comparison result. To distinguish the pixels (thick cloud pixels) constituting the first thick cloud area, the first thick cloud area generation unit 13 may store 1 as a value related to the thick cloud pixel and 0 as a value related to the other pixels.

The second thick cloud area generation unit 14 uses the less cloud image of the set of images generated by the cloud amount comparison unit 12 as an input, and generates and outputs a second thick cloud area (A_{y}: see the right side of the pattern example (a) in FIG. 6) including a cloud thick enough not to transmit the light from the ground surface in the less cloud image. The second thick cloud area generation unit 14 may perform the same operation as the first thick cloud area generation unit 13. To distinguish the pixels (thick cloud pixels) constituting the second thick cloud area, the second thick cloud area generation unit 14 may store 1 as a value related to the thick cloud pixel and 0 as a value related to the other pixels.

The synthesis unit 15 uses the first thick cloud area in the more cloud image and the second thick cloud area in the less cloud image as inputs and executes a first operation for at least one of the first thick cloud area and the second thick cloud area to generate a first mask for masking the first thick cloud area in the less cloud image. Moreover, the synthesis unit 15 executes a second operation for at least one of the first thick cloud area and the second thick cloud area to generate a second mask for masking the second thick cloud area in the more cloud image. The synthesis unit 15 may perform predetermined operation processing using the first thick cloud area and the second thick cloud area as inputs, as synthesis processing, and generate the first mask for the more cloud image and the second mask for the less cloud image as a result of the operation processing.

For example, as illustrated in the patterns (a) and (b) in FIG. 6, the synthesis unit 15 substitutes the first thick cloud area (Aₓ) extracted from the more cloud image and the second thick cloud area (A_{y}) extracted from the less cloud image to an operation 1 and an operation 2, and generates the first mask (input mask: Mᵢₙ) for the more cloud image from the result of the operation 1 and generates the second mask (target mask: M_{tg}) for the less cloud image from the calculation result of the operation 2. At this time, the value “1” related to the thick cloud is stored in the pixels of the first thick cloud area, the second thick cloud area, the first mask, and the second mask. The following expressions (1) and (2) are used for the operation 1 (first operation) and the operation 2 (second operation) illustrated in the patterns (a) and (b) in FIG. 6. In the following expression, max refers to an OR operation. Further, (i, j) is coordinate values indicating the position of each pixel in the image.

Operation 1:Mᵢₙ(i,j)=A_{y}(i,j) (1)

Operation 2:M_{tg}(i,j)=max(Aₓ(i,j),A_{y}(i,j)) (2)

The above expressions are examples of operations, and the following expressions (3) and (4) may be used for the operations.

Operation 1:Mᵢₙ(i,j)=max(Aₓ(i,j),A_{y}(i,j)) (3)

Operation 2:M_{tg}(i,j)=max(Aₓ(i,j),A_{y}(i,j)) (4)

The types of the operations are not limited to the above. For example, an AND operation may be performed in the expression (2). The second mask is equal to or larger than the first mask in size.

The first mask unit 16 substitutes a default value (for example, 1) to the pixels of the first mask generated by the synthesis unit 15 and generates and outputs a masked more cloud image (first mask image) on the more cloud image of the set of images generated by the cloud amount comparison unit 12. The first mask unit 16 may output a calculation result Iₘ of the following expression (5) as data of the first mask image. Here, I_{c} (i, j) is the luminance value of each pixel of the more cloud image, Mᵢₙ (i, j) is the first mask for the more cloud image, and D is a maximum luminance value of the image used as a default value. The default value D is, for example, a pixel value (255, 255, 255) in the case where an image format is an 8-bit RGB (red, green, and blue) color image. Further, the default value D may be a representative observation value of the thick cloud area stored in advance.

Iₘ(i,j)=(1−Mᵢₙ(i,j))·I_{c}(i,j)+D·Mᵢₙ(i,j) (5)

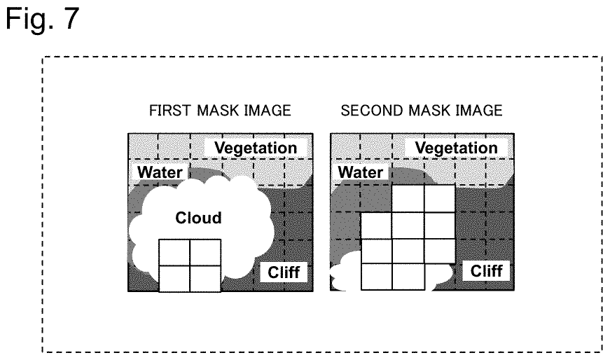

The first mask unit 16 may superimpose the more cloud image and the first mask Mᵢₙ and output a superimposed image as the first mask image (see FIG. 7). The second mask unit 17 substitutes a default value to each pixel of the second mask in the less cloud image to generate a second mask image. The second mask unit 17 substitutes the second mask M_{tg} to the expression (5) and outputs a calculation result Iₘ as second mask image data, for the less cloud image, similarly to the first mask unit 16. Alternatively, the second mask unit 17 may superimpose the less cloud image and the second mask M_{tg} and output a superimposed image as a masked less cloud image (second mask image, see FIG. 7).

The first mask unit 16 and the second mask unit 17 store the first mask image and the second mask image that capture the same location at different times as a set of learning data in the learning data set storage unit 102. The image sets stored in the learning data set storage unit 102 do not include the thick cloud area (that is masked) and only the thin cloud area is reflected. Therefore, by causing the learning unit 103 to learn the image sets as learning data, the learning unit 103 capable of correctly correcting a thin cloud can be generated.

(Operation of Learning Data Set Generation Device)

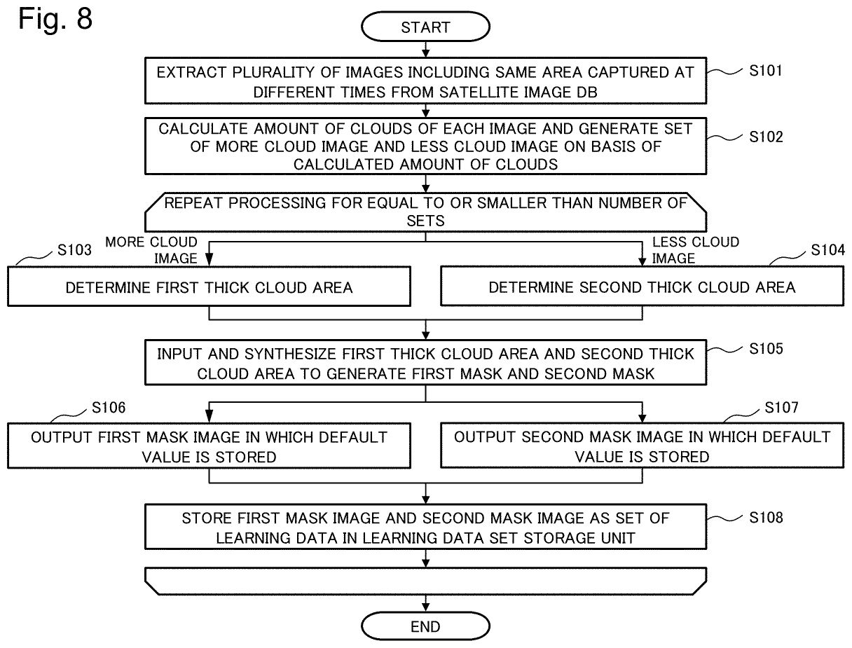

FIG. 8 is a flowchart illustrating the operation of the learning data set generation device 100 according to the first example embodiment of the present invention.

In step S101, the same-point image extraction unit 11 extracts a plurality of images each including the same location captured at a different time as an observation object from the satellite image DB 101 that stores satellite images obtained by remote sensing and information related to the images, and outputs the plurality of images as the same-point images.

In step S102, the cloud amount comparison unit 12 calculates the cloud amount included in each image of the plurality of same-point images each including the same location as the observation object, and generates the set of the more cloud image and the less cloud image in accordance with the calculated cloud amount. For example, the cloud amount comparison unit 12 compares the value (for example, the luminance value) stored in each pixel with the default value, and determines a pixel having a value larger than the default value as a part of the cloud area. From the viewpoint of learning, it is favorable to use an image having the largest cloud amount as the input image and use an image having the smallest cloud amount as the target image.

Hereinafter, steps S103 to S108 are repeated by the number of image sets generated by the cloud amount comparison unit 12 (loop processing).

In step S103, the first thick cloud area generation unit 13 determines and outputs the first thick cloud area included in the more cloud image, using the more cloud image of the image set generated by the cloud amount comparison unit 12 as an input.

In step S104, the second thick cloud area generation unit 14 determines and outputs the second thick cloud area included in the less cloud image, using the less cloud image of the image set generated by the cloud amount comparison unit 12 as an input.

In step S105, the synthesis unit 15 synthesizes the first thick cloud area output from the more cloud image and the second thick cloud area output from the less cloud image, and generates the first mask for the more cloud image and the second mask for the less cloud image, using a synthesis result. The synthesis may be predetermined operation processing. The operation processing of the first thick cloud area and the operation processing of the second thick cloud area may be different or the same.

In step S106, the first mask unit 16 substitutes the default value (for example, 1) to each pixel of the first mask synthesized by the synthesis unit 15 and outputs the first mask image on the more cloud image of the above-described image set. The first mask image and the more cloud image may be superimposed on each other.

In step S107, the second mask unit 17 substitutes the default value (for example, 1) to each pixel of the second mask synthesized by the synthesis unit 15 and outputs the second mask image on the less cloud image of the above-described image set. The second mask image and the less cloud image may be superimposed on each other.

In step S108, the first mask image output from the first mask unit 16 and the second mask image output from the second mask unit 17 are stored as a set of learning data in the learning data set storage unit 102.

Thus, the operation of the learning data set generation device 100 ends.

### Effects of the First Example Embodiment

The learning data set generation device 100 according to the first example embodiment can generate a learning data set suitable for cloud correction processing using a natural cloud image. The reason for this is that, when using the actually observed image as the learning data set for cloud removal, the learning data set generation device 100 performs the mask processing for the thick cloud area including the thick cloud that does not transmit the light from the ground surface, which is inappropriate as the learning data set, to exclude the thick cloud area from the target area of the learning data set, and uses only the thin cloud as the learning data set.

### Second Example Embodiment

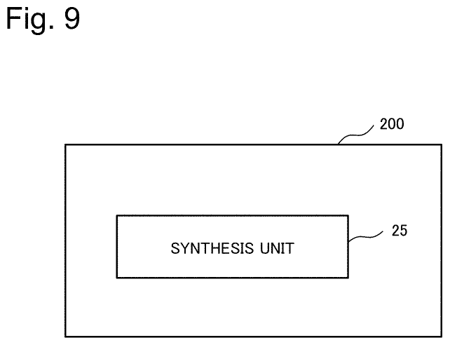

A learning data set generation device 200 according to the second example embodiment of the present invention includes a synthesis unit 25, as illustrated in FIG. 9. The synthesis unit 25 has a more cloud image including a cloud and a less cloud image including a smaller cloud amount than the more cloud image or not including a cloud among images including a same observation object as a set, uses a first thick cloud area indicating a pixel of a thick cloud in the more cloud image and a second thick cloud area indicating a pixel of the thick cloud in the less cloud image as inputs, and executes a first operation for at least one of the first thick cloud area and the second thick cloud area to generate a first mask for masking the first thick cloud area in the less cloud image. Moreover, the synthesis unit 25 executes a second operation for at least one of the first thick cloud area and the second thick cloud area to generate a second mask for masking the second thick cloud area in the more cloud image. The set including information (data) including the generated first mask and the more cloud image, and information (data) including the generated second mask and the less cloud image is adopted as learning data.

According to the second example embodiment of the present invention, a learning data set suitable for cloud correction processing can be generated using a natural cloud image. The reason for this is that, the synthesis unit 25 of the learning data set generation device 200 performs the mask processing for the thick cloud area including the thick cloud that does not transmit light from a ground surface, which is inappropriate as the learning data set, to exclude the thick cloud area from a target area of the learning data set.

(Information Processing Device)

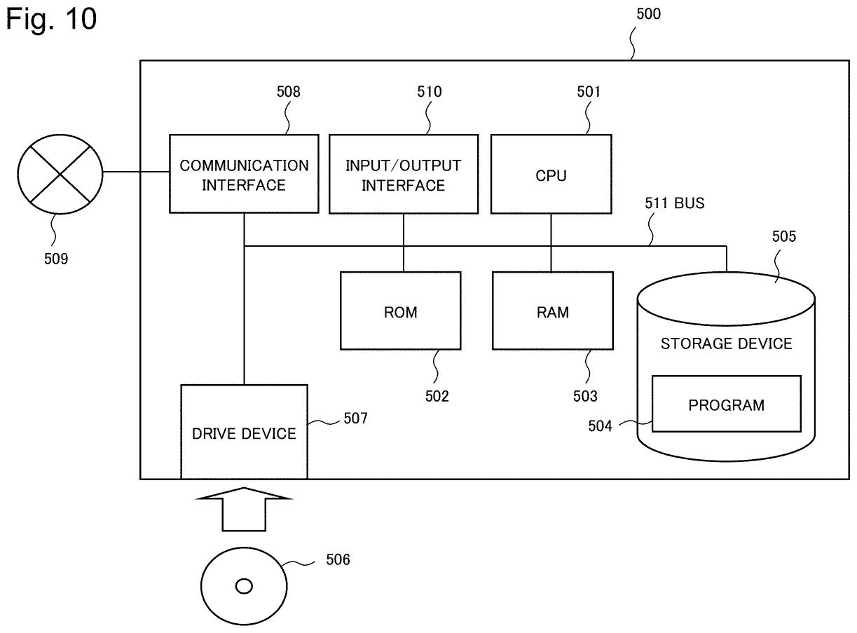

In each of the above-described example embodiments of the present invention, some or all of the constituent elements in the learning data set generation device illustrated in FIG. 4, 9, or the like can be implemented using any combination of an information processing device 500 illustrated in FIG. 10 and a program, for example. The information processing device 500 includes, as an example, the following configuration.
Central processing unit (CPU) 501
Read only memory (ROM) 502
Random access memory (RAM) 503
Storage device 505 that stores a program 504 and other data
Drive device 507 that reads and writes a recording medium 506
Communication interface 508 connected to a communication network 509
Input/output interface 510 that inputs or outputs data
Bus 511 connecting constituent elements

The constituent elements of the learning data set generation device in each example embodiment of the present application are implemented by the CPU 501 acquiring and executing the program 504 for implementing the functions of the constituent elements. The program 504 for implementing the functions of the constituent elements of the learning data set generation device is stored in advance in the storage device 505 or the RAM 503, for example, and is read by the CPU 501 as necessary. The program 504 may be supplied to the CPU 501 through the communication network 509 or may be stored in the recording medium 506 in advance and the drive device 507 may read and supply the program to the CPU 501.

There are various modifications to the implementation method of each device. For example, the learning data set generation device may be implemented by any combination of an individual information processing device and a program for each constituent element. Furthermore, a plurality of constituent elements provided in the learning data set generation device may be implemented by any combination of one information processing device 500 and a program.

Further, some or all of the constituent elements of the learning data set generation device are implemented by another general-purpose or dedicated circuit, a processor, or a combination thereof. These elements may be configured by a single chip or a plurality of chips connected via a bus.

Some or all of the constituent elements of the learning data set generation device may be implemented by a combination of the above-described circuit, and the like, and a program.

In the case where some or all of the constituent elements of the learning data set generation device are implemented by a plurality of information processing devices, circuits, and the like, the plurality of information processing devices, circuits, and the like may be arranged in a centralized manner or in a distributed manner. For example, the information processing devices, circuits, and the like may be implemented as a client and server system, a cloud computing system, or the like, in which the information processing devices, circuits, and the like are connected via a communication network.

While the invention has been particularly shown and described with reference to the example embodiments thereof, the invention is not limited to these example embodiments. It will be understood by those of ordinary skill in the art that various changes in form and details may be made therein without departing from the spirit and scope of the present invention as defined by the claims.

### INDUSTRIAL APPLICABILITY

The invention of the present application can be used for making a map, grasping a state of land use, grasping a situation of volcanic eruptions or forest fires, acquiring a growth level of crops, and discriminating minerals, based on a result of measuring a ground surface from a high place.

### REFERENCE SIGNS LIST

11 same-point image extraction unit
12 cloud amount comparison unit
13 first thick cloud area generation unit
14 second thick cloud area generation unit
15 synthesis unit
16 first mask unit
17 second mask unit
25 synthesis unit
100 learning data set generation device
101 satellite image database
102 learning data set storage unit
103 learning unit
200 learning data set generation device
500 information processing device
501 CPU
503 RAM
504 program
505 storage device
506 recording medium
507 drive device
508 communication interface
509 communication network
510 input/output interface
511 bus

What is claimed is:

1. A learning data set generation device comprising:
a processor;
a memory having stored therein computer instructions,
the instructions causing the processor acting as:
a synthesis unit configured to
have a more cloud image and a less cloud image including a same observation object as a set, the more cloud image including a cloud and the less cloud image including a smaller amount of cloud than the more cloud image or including no cloud therein, and receive, as inputs, a first thick cloud area indicating pixels of a thick cloud in the more cloud image and a second thick cloud area indicating pixels of the thick cloud in the less cloud image,
execute a first operation for at least one of the first thick cloud area and the second thick cloud area to generate a first mask for masking the first thick cloud area in the less cloud image, and
execute a second operation for at least one of the first thick cloud area and the second thick cloud area to generate a second mask for masking the second thick cloud area in the more cloud image,
wherein
the set to be adapted as learning data including
information including the generated first mask and the more cloud image, and
information including the generated second mask and the less cloud image.

2. The learning data set generation device according to claim 1, the processor further comprising:
a cloud amount comparison unit configured to
calculate the cloud amount included in each image in a plurality of images each including the same observation object,
compare the calculated cloud amount with the default value, and
generate a set of the more cloud image having a cloud amount larger than a default value and the less cloud image having the cloud amount smaller than the default value.

3. The learning data set generation device according to claim 1, the processor further comprising:
a mask unit configured to
substitute a default value to each pixel of the first mask in the more cloud image of the set to generate a first mask image that is data including the first mask, and
substitute the default value to each pixel of the second mask in the less cloud image of the set to generate a second mask image that is data including the second mask.

4. The learning data set generation device according to claim 1, wherein
the more cloud image of the set is an input for the learning, and the less cloud image of the set is to be targeted for the learning.

5. The learning data set generation device according to claim 3, wherein
the second mask is equal to or larger than the first mask in size.

6. A learning data set generation method comprising:
having a more cloud image and a less cloud image including a same observation object as a set, the more cloud image including a cloud and the less cloud image including a smaller amount of cloud than the more cloud image or including no cloud therein and, receiving a first thick cloud area indicating pixels of a thick cloud in the more cloud image and a second thick cloud area indicating pixels of the thick cloud in the less cloud image;
executing a first operation for at least one of the first thick cloud area and the second thick cloud area to generate a first mask for masking the first thick cloud area in the less cloud image;
executing a second operation for at least one of the first thick cloud area and the second thick cloud area to generate a second mask for masking the second thick cloud area in the more cloud image; and
adopting, as learning data, the set including
data including the generated first mask and the more cloud image, and
data including the generated second mask and the less cloud image.

7. A non-transitory computer readable recording medium storing a learning data set generation program for causing a computer to implement:
having a more cloud image and a less cloud image including a same observation object as a set, the more cloud image including a cloud and the less cloud image including a smaller amount of cloud than the more cloud image or including no cloud therein, and receiving a first thick cloud area indicating pixels of a thick cloud in the more cloud image and a second thick cloud area indicating pixels of the thick cloud in the less cloud image;
executing a first operation for at least one of the first thick cloud area and the second thick cloud area to generate a first mask for masking the first thick cloud area in the less cloud image;
executing a second operation for at least one of the first thick cloud area and the second thick cloud area to generate a second mask for masking the second thick cloud area in the more cloud image; and
adopting, as learning data, the set including
data including the generated first mask and the more cloud image, and
data including the generated second mask and the less cloud image.

8. The learning data set generation device according to claim 2, the processor further comprising:
a mask unit configured to
substitute a default value to each pixel of the first mask in the more cloud image of the set to generate a first mask image that is data including the first mask, and
substitute the default value to each pixel of the second mask in the less cloud image of the set to generate a second mask image that is data including the second mask.

9. The learning data set generation device according to claim 2, wherein
the more cloud image of the set is an input for the learning, and the less cloud image of the set is to be targeted for the learning.

10. The learning data set generation device according to claim 3, wherein
the more cloud image of the set is an input for the learning, and the less cloud image of the set is to be targeted for the learning.

11. The learning data set generation device according to claim 1, wherein
the second mask is equal to or larger than the first mask in size.

12. The learning data set generation device according to claim 2, wherein
the second mask is equal to or larger than the first mask in size.

13. The learning data set generation device according to claim 4, wherein
the second mask is equal to or larger than the first mask in size.
